(19) United States
(12) Patent Application Publication
(10) Pub. No.: US 2026/0252320 A1
(43) Pub. Date: Aug. 27, 2026

(54) METHOD AND SYSTEM FOR MULTI-AGENT BASED CODE GENERATION

(71) Applicant: Wipro Limited, Bangalore (IN)

(72) Inventor: Sk Mohammad ARIF, Kolkata (IN)

(73) Assignee: Wipro Limited, Bangalore (IN)

(21) Appl. No.: 19/173,951

(22) Filed: Apr. 9, 2025

(30) Foreign Application Priority Data
Feb. 21, 2025 (IN) 202541015199

(51) Int. Cl. G06F 8/35; G06F 8/34

(52) U.S. Cl. CPC G06F 8/35; G06F 8/34

(57) ABSTRACT

This disclosure relates to method and system of multi-agent based code generation. The method may include receiving a name of a target module from a User Interface. Based on the name of the target module, the method may include retrieving software architecture design details and visual data insights from a first knowledge base, and a design guidelines summary and a module implementation report from a second knowledge base. The method may further include generating, through a Large Language Model (LLM) unit, a high-level pseudocode for the target module based on the software architecture design details and visual data insights; generating an executable code corresponding to the target module based on the high-level pseudocode; generating an optimized code from the executable code based on the design guidelines summary; and reviewing the optimized code based on the module implementation report to obtain a final code corresponding to the target module.

### TECHNICAL FIELD

This disclosure relates generally to code generation, and more particularly to method and system for multi-agent based code generation.

### BACKGROUND

In software development, creating a high-quality contextualized code that may align with requirements of a software and also adheres to coding standards and design patterns is a complex task. Typically, developers first analyze and understand detailed requirements of the software. Then, the developers interpret various diagrams (for example, Unified Modeling Language (UML), data flow diagrams, etc.) based on the requirements of the software to accurately capture system functionalities and component interactions. Such a process of analysis and interpretation demands significant manual efforts, followed by a challenging task of translating the requirements into a structured and functional code.

Further, ensuring that the generated code meets both functional requirements and technical standards may require additional rounds of manual optimization and thorough review. The manual stages (from requirement analysis to code development, optimization, and review) may be prone to errors and inconsistencies, and may require a significant amount of time at each step. In a present state of the art, techniques for automated code generation lack opportunities for code review. The code generated through such techniques may include inefficiencies or errors that may go unchecked, and may potentially impact performance and maintainability of the software.

Thus, the present invention is directed to overcome one or more limitations stated above or any other limitations associated with the known arts.

### SUMMARY

In one embodiment, a method of multi-agent based code generation is disclosed. In one example, the method may include receiving a name of a target module from a User Interface (UI). The target module is one of a plurality of modules in an existing codebase. Based on the name of the target module, the method may further include retrieving software architecture design details and visual data insights from a first knowledge base, and a design guidelines summary and a module implementation report from a second knowledge base. The first knowledge base is a vector database based on software architecture design documents. The second knowledge base is a vector database based on domain-specific design documents and the existing codebase. The method may further include generating, through a Large Language Model (LLM) unit, a high-level pseudocode corresponding to the target module based on the software architecture design details and the visual data insights. The method may further include generating, through the LLM unit, an executable code corresponding to the target module based on the high-level pseudocode. The method may further include generating, through the LLM unit, an optimized code from the executable code based on the design guidelines summary. The method may further include reviewing, through the LLM unit, the optimized code based on the module implementation report to obtain a final code corresponding to the target module.

In one embodiment, a system for multi-agent based code generation is disclosed. In one example, the system may include a processor and a computer-readable medium communicatively coupled to the processor. The computer-readable medium may store processor-executable instructions, which, on execution, may cause the processor to receive a name of a target module from a User Interface (UI). The target module is one of a plurality of modules in an existing codebase. Based on the name of the target module, the processor-executable instructions, on execution, may further cause the processor to retrieve software architecture design details and visual data insights from a first knowledge base, and a design guidelines summary and a module implementation report from a second knowledge base. The first knowledge base is a vector database based on software architecture design documents. The second knowledge base is a vector database based on domain-specific design documents and the existing codebase. The processor-executable instructions, on execution, may further cause the processor to generate, through the LLM unit, a high-level pseudocode corresponding to the target module based on the software architecture design details and the visual data insights. The processor-executable instructions, on execution, may further cause the processor to generate, through the LLM unit, an executable code corresponding to the target module based on the high-level pseudocode. The processor-executable instructions, on execution, may further cause the processor to generate, through the LLM unit, an optimized code from the executable code based on the design guidelines summary. The processor-executable instructions, on execution, may further cause the processor to review, through the LLM unit, the optimized code based on the module implementation report to obtain a final code corresponding to the target module.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for multi-agent based code generation, in accordance with some embodiments.

FIG. 2 is a functional block diagram of an exemplary system for multi-agent based code generation, in accordance with some embodiments.

FIG. 3 is a flow diagram of an exemplary process for generating software architecture design details, in accordance with some embodiments.

FIG. 4 is a flow diagram of an exemplary process for generating the design guidelines summary, in accordance with some embodiment.

FIG. 5 is a flow diagram of an exemplary process for generating the module implementation report, in accordance with some embodiments.

FIG. 6 is a flow diagram of an exemplary process for multi-agent based code generation, in accordance with some embodiments

FIG. 7 is a flow diagram of a detailed exemplary process for multi-agent based code generation, in accordance with an embodiment.

FIG. 8 is a block diagram of an exemplary process for creating internal knowledge base from the software architecture design documents, in accordance with an embodiment.

FIG. 9 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

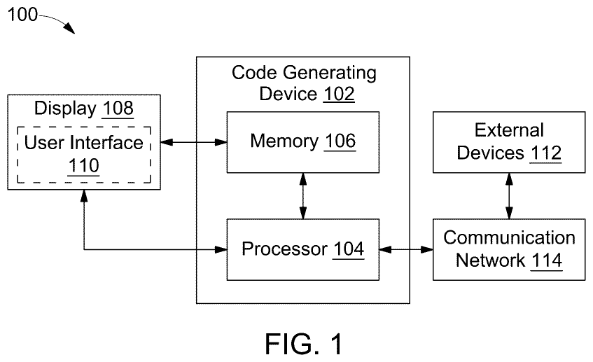

Referring now to FIG. 1, an exemplary system 100 for multi-agent based code generation is illustrated, in accordance with some embodiments. The system 100 may include a code generating device 102 (for example, a server, a desktop, a laptop, a notebook, a netbook, a tablet, a smartphone, a mobile phone, or any other computing device), in accordance with some embodiments of the present disclosure. The code generating device 102 may automatically generate a high quality, contextualized code utilizing a multi-agent system using a Retrieval Augmented Generation (RAG) unit and a Large Language Model (LLM) unit. The multi-agent system may be designed to handle different stages of the code generation process. The multi-agent system may include specialized agents responsible for constructing pseudocode, generating code, optimizing code, and conducting code reviews. Each agent may operate autonomously but in collaboration with others, guided by LLMs with structured prompts.

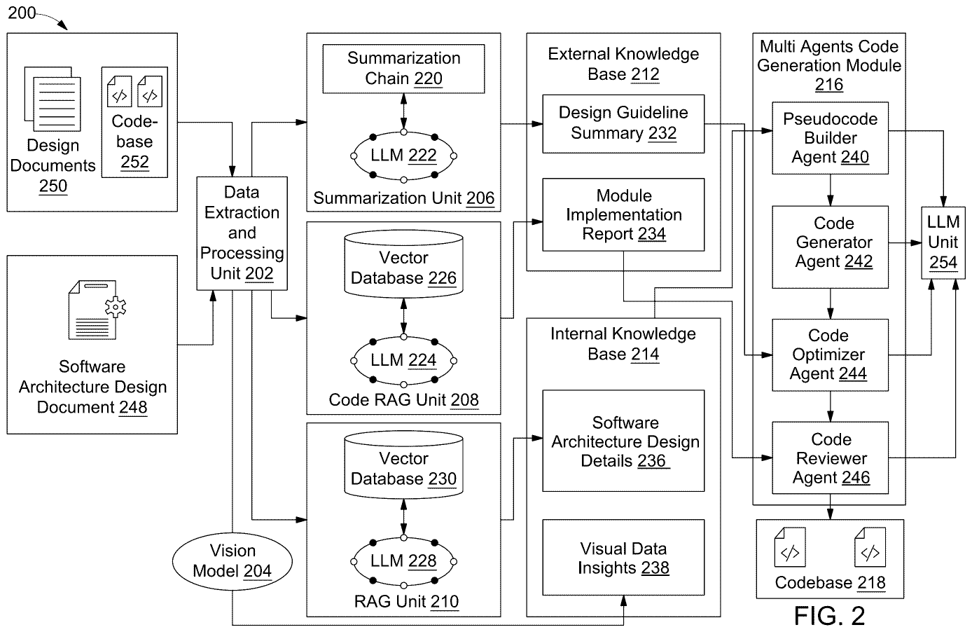

As will be described in greater detail in conjunction with FIGS. 2-22, the code generating device 102 may receive a name of a target module from a User Interface (UI). The target module is one of a plurality of modules in an existing codebase. Based on the name of the target module, the code generating device 102 may retrieve software architecture design details and visual data insights from a first knowledge base, and a design guidelines summary and a module implementation report from a second knowledge base. The first knowledge base is a vector database based on software architecture design documents. The second knowledge base is a vector database based on domain-specific design documents and the existing codebase.

Thereafter, the code generating device 102 may generate, through a Large Language Model (LLM) unit, a high-level pseudocode corresponding to the target module based on the software architecture design details and the visual data insights. The code generating device 102 may generate, through the LLM unit, an executable code corresponding to the target module based on the high-level pseudocode. The code generating device 102 may generate, through the LLM unit, an optimized code from the executable code based on the design guidelines summary. The code generating device 102 may review, through the LLM unit, the optimized code based on the module implementation report to obtain a final code corresponding to the target module.

In some embodiments, the code generating device 102 may include one or more processors 104 and a memory 106. The memory 106 may store instructions that, when executed by the one or more processors 104, may cause the one or more processors 104 to generate multi-agent based code, in accordance with aspects of the present disclosure. The memory 106 may also store various data (for example, a set of documents, summarization instructions, a set of topics, or the like) that may be captured, processed, and/or required by the code generating device 102. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The system 100 may further include a display 108. The system 100 may interact with a user via a user interface 110 accessible via the display 108. The system 100 may also include one or more external devices 112. In some embodiments, the code generating device 102 may interact with the one or more external devices 112 over a communication network 114 for sending or receiving various data. The external devices 112 may include, but may not be limited to, a remote server, a digital device, or another computing system. In an embodiment, the external devices 112 may include an external LLM server.

Referring now to FIG. 2, a functional block diagram of an exemplary system 200 for multi-agent based code generation is illustrated, in accordance with some embodiments. FIG. 2 is explained in conjunction with FIG. 1. The system 200 may include, within a memory (such as the memory 106), a data extraction and processing unit 202, a vision model 204, a summarization unit 206, a code RAG unit 208, a RAG unit 210, an external knowledge base 212, an internal knowledge base 214, a multi-agent code generation module 216, a codebase 218, and an LLM unit 254. In some embodiments, the external knowledge base 212 may be located external to the memory (for example, in an external computing device that may be communicatively coupled with the system 200).

The summarization unit 206 may include a summarization chain 220 and a first LLM unit 222. The code RAG unit 208 may include a second LLM unit 224 and a first vector database 226. The RAG unit 210 may include a third LLM unit 228 and a second vector database 230. The external knowledge base 212 may include a design guideline summary 232 and a module implementation report 234. The internal knowledge base 214 may include a set of software architecture design details 236 and a set of visual data insights 238 (i.e., insights derived from visual data). The multi-agent code generation module 216 may include a pseudocode builder agent 240, a code generator agent 242, a code optimizer agent 244, and a code reviewer agent 246.

The data extraction and processing unit 202 may receive a name of a target module from a User Interface (UI). The target module may be one of a plurality of modules in an existing codebase of a software. The target module may be a module for which the code is to be generated. Additionally, the data extraction and processing unit 202 may receive software architecture design documents 248, domain-specific design documents 250, and links to existing codebases 252. The software architecture design documents 248 may outline high-level structure of a software system. The software architecture design documents 248 may define architectural components, interaction of the architectural components, data flow, dependencies, and alignment of a system with a functional and a non-functional requirement. The software architecture design documents 248 may typically include diagrams such as state transition diagrams, data flow diagrams, use case diagrams, and other visual representations to clarify system design. The software architecture design documents 248 may serve as a blueprint for developers and additionally may provide both textual and visual guidance, aiding in effective code implementation. It should be noted that the software architecture design documents 248 may be created during the design phase of a software project by a software architect or a software designer.

The domain-specific design documents 250 may capture design details focused on a specific domain (by way of an example, an automotive domain, a healthcare domain, a finance domain, or the like). The domain-specific design documents 250 may provide domain-relevant standards, protocols, design patterns, and implementation guidelines. By way of an example, in the automative domain, the domain specific design documents may include information about AUTOSAR standards, ISO 26262 safety guidelines, and specific communication protocols such as CAN or LIN. The codebase 252 may be internal (proprietary) or external (open-source platforms such as GitHub®), depending on needs of a project. It should be noted that the domain-specific design documents 250 may be created by domain experts, architects, or organizations operating within a specific domain.

The data extraction and processing unit 202 may extract data from the software architecture design documents 248, the domain-specific design documents 250, and the codebase 252. To extract data, the data extraction and processing unit 202 may process the domain-specific design documents 250 and the software architecture design documents 248. The data extraction and processing unit 202 may extract data in text format corresponding to the software architecture design documents 248 and the domain-specific design documents 250 by text parsing (for example, Python text parsing libraries). Further, the data extraction and processing unit 202 may send the extracted data in text format from the software architecture design documents 248 to the RAG unit 210. The data extraction and processing unit 202 may send the extracted data in text format from the domain specific design documents 250 to the summarization unit 206. Additionally, the data extraction and processing unit 202 may extract visual data (from Unified Modeling Languages (UML) and Entity Relationship (ER) diagrams) from the software architecture design documents 248 in image format using tools (for example, Python libraries such as PyPDF2, PyMuPDF, etc.) through the vision model 204. It should be noted that the vision model 204 may include a fourth LLM unit in an external LLM server. Once the visual data is extracted, the data extraction and processing unit 202 may extract text data (i.e., the set of visual data insights 238 derived from the UML and ER diagrams) corresponding to the visual data. Further, the data extraction and processing unit 202 may send the set of visual data insights 238 to the internal knowledge base 214. The set of visual data insights 238 may include visual data (from UML and ER diagrams) extracted from the software architecture design document 248 and the domain-specific design documents 250. Additionally, the data extraction and processing unit 202 may send the signal about the completion of generation of the set of visual data insights 238 to the pseudocode builder agent 240

The data extraction and processing unit 202 may send a plurality of queries for scrapping data from the existing codebases (through links to the existing codebases) to Internet (various servers of the existing codebases). Once the data is scrapped, the data extraction and processing unit 202 may receive scrapped data i.e., codebase from the Internet. The data extraction and processing unit 202 may send the scraped data (codebase) along with the name of the target module to the code RAG unit 208.

Once, the extracted data in text format corresponding to the software architecture design documents 248 is received, the RAG unit 210 may create a first set of architecture chunks corresponding to the software architecture design documents 248 using a text splitter (for example, using RecursiveCharacterTextSplitter function from langchain_text_splitters package). Further, the RAG unit 210 may create a first set of architecture embeddings based on the first set of architecture chunks using an embedding model (for example, using Amazon Titan). The first set of architecture embeddings may capture the semantic meaning of the text, enabling context-aware search. Further, the RAG unit 210 may store the first set of architecture embeddings in the second vector database 230 for efficient similarity-based retrieval.

Further, the RAG unit 210 may input a primary details generation prompt to the third LLM unit 228. The primary details generation prompt may include the first set of architecture embeddings and instructions corresponding to individual generation of primary software architecture design details. In some embodiments, each of the first LLM unit 222, the second LLM unit 224, the third LLM unit 228, and the LLM unit used by the vision model 204 may include the same LLM configured to retrieve embeddings from different vector databases. Alternatively, each of the first LLM unit 222, the second LLM unit 224, the third LLM unit 228, and the LLM unit used by the vision model 204 may include different LLMs trained and configured to perform their respective functions. By way of an example, the LLM may be, but may not be limited to, Generative Pre-trained Transformer (GPT)-3, GPT-3.5, GPT-4, Language Model for Dialogue Applications (LaMDA), Pathways Language Model (PaLM), Gemini, Claude, BigScience Large Open-science Open-access Multilingual Language Model (BLOOM), Large Language Model Meta AI (Llama), Mistral 7B, Mixtral 8x7B, Mixtral 8x22B, or the like.

Further, the third LLM unit 228 may generate primary software architecture design details in response to the primary details generation prompt. Further, the third LLM unit 228 may generate an individual query corresponding to each of the primary software architecture design details from a high-level query using a structured prompt. The individual query may be sent to the RAG unit 210. Based on the individual query, the RAG unit 210 may create a second set of architecture embeddings. Further, the RAG unit 210 may compare the second set of architecture embeddings and the first set of architecture embeddings using a similarity search to obtain relevant embeddings from the first set of architecture embeddings. Further, the RAG unit 210 may input a secondary details generation prompt to the third LLM unit 228. The secondary details generation prompt may include the relevant embeddings and instructions corresponding to individual generation of the software architecture design details. Further, the third LLM unit 228 may generate the software architecture design details 236 in response to the secondary details generation prompt. The third LLM unit 228 may send the software architecture design details 236 to the RAG Unit 210. The RAG Unit 210 may store the software architecture design details 236 in the internal knowledge base 214 (i.e., the first knowledge base). The software architecture design details 236 may include module specifications, data flow, state management, and module relationships. Additionally, the RAG unit 210 may send a signal to the pseudocode builder agent 240 about the completion of generation of the software architecture design details 236.

Further, to generate the design guidelines summary 232, the data extraction and processing unit 202 may extract data from the domain-specific design documents 250 in text format by text parsing. Further, the data extraction and processing unit 202 may send the extracted data to the summarization unit 206. The summarization unit 206 may create a set of design chunks corresponding to the domain-specific design documents 250 using a text splitter. Each set of the design chunk may represent a document. Further, the summarization unit 206 may input a primary summarization prompt to the first LLM unit 222. The primary summarization prompt may include the set of design chunks and instructions corresponding to individual summary generation of each of the set of design chunks. Further, the first LLM unit 222 may generate a summary corresponding to each of the set of design chunks in response to the primary summarization prompt using the summarization chain 220. Further, the summarization unit 206 may input a secondary summarization prompt to the first LLM unit 222. The secondary summarization prompt may include the summary and instructions corresponding to generation of the design guidelines summary based on the summary. Further, the first LLM unit 222 may generate the design guidelines summary 232 in response to the secondary summarization prompt using the summarization chain 210. The design guidelines summary 232 may include coding standards, design patterns, best practices, and implementation strategies. The design guidelines summary 232 may be a consolidated summary based on the summary for each of the set of design chunks. Further, the first LLM unit 222 may send the design guidelines summary 232 to the summarization unit 206. Further, the summarization unit 206 may store design guidelines summary in the external knowledge base 212 (i.e., the second knowledge base). Additionally, the summarization unit 206 may send the signal about the completion of the generation of the design guideline summary 232 to the pseudocode builder agent 240.

Further, to generate the module implementation report 234, the data extraction and processing unit 202 may send the existing codebase 252 and name of the target module to the code RAG unit 208. The existing codebase 252 may be parsed using techniques by using file loader packages (for example, using GenericLoader function from langchain_community.document_loaders.generic package and LanguageParser function from langchain_community.document_loaders.parsers package). The code RAG unit 208 may split the existing codebase 252 into the plurality of modules using a text splitter (for example, RecursiveCharacterTextSplitter function from langchain_text_splitters package with language of the code specified as a parameter).

Further, the code RAG unit 208 may create a set of module embeddings from the plurality of modules using an embedding model. The code RAG unit 208 may store the set of module embeddings in the first vector database 226. Further, the code RAG unit 208 may create a set of target module embeddings from the name of the target module using an embedding model. Once the set of target module embeddings is created, the code RAG unit 208 may compare the set of module embeddings and the set of target module embeddings using a similarity search to obtain relevant module embeddings from the set of module embeddings. The code RAG unit 208 may input a report generation prompt to the second LLM unit 224. The report generation prompt may include the relevant module embeddings and instructions corresponding to generation of the module implementation report. The second LLM unit 224 may generate the module implementation report 234 in response to the report generation prompt. The module implementation report 234 may include core functionalities and implementation details of the target module. The second LLM unit 224 may send the module implementation report 234 to the code RAG unit 208. The code RAG unit 208 may store the module implementation report 234 in the second knowledge base i.e., the external knowledge base 212. Additionally, the code RAG unit 208 may send the signal about the completion of generation of the module implementation report to the pseudocode builder agent 240.

Based on the target module, the data extraction and processing unit 202 may retrieve software architecture design details 236 and the set of visual data insights 238 from the internal knowledge base 214, and the design guidelines summary 232 and the module implementation report 234 from the external knowledge base 212. It should be noted that the internal knowledge base 214 is a vector database based on software architecture design documents 248. The internal knowledge base 214 may incorporate domain-specific coding standards, design pattern from the domain specific design documents 250 using a summarization technique and module implementation strategies drawn from prebuilt codebases using RAG technique. The external knowledge base 212 is a vector database based on the domain-specific design documents 250 and the existing codebase 252. The external knowledge base may incorporate the set of visual data insights 238 from UML and Entity Relationships (ER) diagrams using the vision model 204 from the software architecture design documents 248. The external knowledge base may also extract essential details such as module specifications, data flow, state management, and module relationships from the software architecture design documents 248 using RAG technique.

Once the signals about the completion of the generation of the set software architecture design details 236, the design guideline summary 232, the module implementation report 234, and the set of visual data insights 238, the pseudocode builder agent 240 may generate the high-level pseudocode. To generate the high-level pseudocode, the pseudocode builder agent 240 may input a pseudocode generation prompt to the LLM unit 254. The pseudocode generation prompt may include the software architecture design details 236 and instructions corresponding to generation of the high-level pseudocode. Further, the LLM unit 254 may generate the high-level pseudocode in response to the pseudocode generation prompt. The LLM unit 254 may send the high-level pseudocode to the pseudocode builder agent 240. The pseudocode builder agent 240 may send the high-level pseudocode to the code generator agent 242.

Further, the code generator agent 242 may generate, through the LLM unit 254, an optimized code from the executable code based on the design guidelines summary 232. To generate an optimized code, the code generator agent 242 may generate the executable code corresponding to the target module. To generate the executable code, the code generator agent 242 may input an executable code generation prompt to the LLM unit 254, once the high-level pseudocode is received. The executable code generation prompt may include the high-level pseudocode and instructions corresponding to generation of the executable code. Further, the LLM unit 254 may generate the executable code in response to the executable code generation prompt. The LLM unit 254 may send the executable code generated to the code generator agent 242. The code generator agent 242 may send the executable code generated to the code optimizer agent 244.

Once, the executable code is generated, the code optimizer agent 244 may generate, through the LLM unit 254, an optimized code from the executable code based on the design guidelines summary 232. To generate the optimized code from the executable code, the code optimizer agent 244 may receive the executable code from the code optimizer agent 244. Additionally, the code optimizer agent 244 may fetch the design guideline summary 232 from the external knowledge base 212. The code optimizer agent 244 may input an optimized code generation prompt to the LLM unit 254. The optimized code generation prompt may include the executable code, the design guidelines summary 232, and instructions corresponding to generation of the optimized code. The LLM unit 254 may generate the optimized code in response to the optimized code generation prompt. The LLM unit 254 may send the optimized code to the code optimizer agent 244. The code optimizer agent 244 may send the optimized code to the code reviewer agent 246.

Once, the optimized code is generated, the code reviewer agent 246 may review, through the LLM unit 254, the optimized code based on the module implementation report 234 to obtain a final code corresponding to the target module. To review the optimized code based on the module implementation report 234, the code reviewer agent 246 may receive the optimized code from the code optimizer agent 244. The code reviewer agent 246 may input a final code generation prompt to the LLM unit 254. The final code generation prompt may include the optimized code, the module implementation report 234, and instructions corresponding to generation of the final code. Further, the LLM unit 254 may generate the final code in response to the final code generation prompt. The LLM unit 254 may send the final code to the code reviewer agent 246. The code reviewer agent 246 may then store the final code in the codebase 218.

It should be noted that all such aforementioned modules 202-218 may be represented as a single module or a combination of different modules. Further, as will be appreciated by those skilled in the art, each of the modules 202-218 may reside, in whole or in parts, on one device or multiple devices in communication with each other. In some embodiments, each of the modules 202-218 may be implemented as dedicated hardware circuit comprising custom application-specific integrated circuit (ASIC) or gate arrays, off-the-shelf semiconductors such as logic chips, transistors, or other discrete components. Each of the modules 202-218 may also be implemented in a programmable hardware device such as a field programmable gate array (FPGA), programmable array logic, programmable logic device, and so forth. Alternatively, each of the modules 202-218 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for multi-agent based code generation. For example, the exemplary system 100 and the associated code generating device 102 may generate multi-agent based code by the processes discussed herein. In particular, as will be appreciated by those of ordinary skill in the art, control logic and/or automated routines for performing the techniques and steps described herein may be implemented by the system 100 and the associated code generating device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

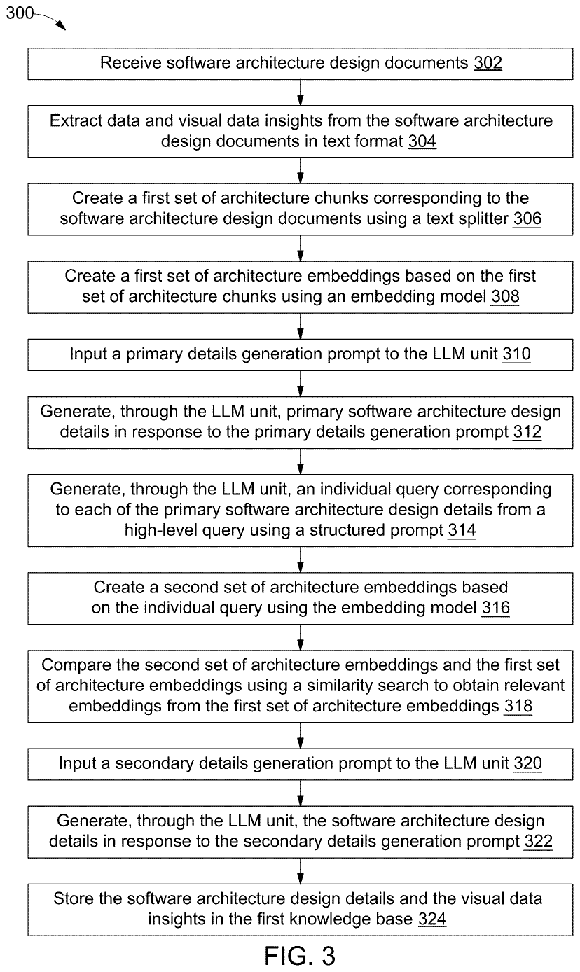

Referring now to FIG. 3, an exemplary process 300 for generating software architecture design details (for example, the software architecture design details 236) is depicted via a flowchart, in accordance with some embodiments. FIG. 3 is explained in conjunction with FIGS. 1 and 2. The process 300 may be implemented by the code generating device 102 of the system 100. The software architecture design details may include module specifications, data flow, state management, and module relationships. The process 300 may include receiving, by a data extraction and processing unit (for example, the data extraction and processing unit 202), software architecture design documents (for example, the software architecture design documents 248), at step 302. Further, the process 300 may include extracting, by a data extracting and processing unit (for example, the data extracting and processing unit 202), data and visual data insights from the software architecture design documents in text format, at step 304. The data may include text data and image data. Additionally, the visual data insights may be extracted using a vision LLM (for example, the vision model 204). The extracted data may be sent to a RAG unit (for example, the RAG unit 210). Further, the process 300 may include creating, by the RAG unit, a first set of architecture chunks corresponding to the software architecture design documents using a text splitter (for example, using RecursiveCharacterTextSplitter function from langchain_text_splitters package), at step 306. Further, the process 300 may include creating, by the RAG unit, a first set of architecture embeddings based on the first set of architecture chunks using an embedding model (for example, using Amazon Titan may captures the semantic meaning of the text, enabling context-aware search), at step 308. The first set of architecture embeddings may be stored in a vector database (for example, the second vector database 230). Further, the process 300 may include inputting, by the RAG unit, a primary details generation prompt to a LLM unit (for example, the third LLM unit 228), at step 310. The primary details generation prompt may include the first set of architecture embeddings and instructions corresponding to individual generation of primary software architecture design details.

Further, the process 300 may include generating, through the LLM unit, primary software architecture design details in response to the primary details generation prompt, at step 312. Further, the process 300 may include generating, through the LLM unit, an individual query corresponding to each of the primary software architecture design details from a high-level query using a structured prompt, at step 314. The individual query may be sent to the RAG unit. Further, the process 300 may include creating, by the RAG unit, a second set of architecture embeddings based on the individual query using the embedding model, at step 316. Further, the process 300 may include comparing, by RAG unit, the second set of architecture embeddings and the first set of architecture embeddings using a similarity search to obtain relevant embeddings from the first set of architecture embeddings, at step 318. The process 300 may include inputting, by the RAG unit, a secondary details generation prompt to the LLM unit, at step 320. The secondary details generation prompt may include the relevant embeddings (context) and instructions corresponding to individual generation of the software architecture design details. Once, the secondary details generation prompt is received, the process 300 may include generating, through the LLM unit, the software architecture design details in response to the secondary details generation prompt, at step 322. The LLM unit may send the software architecture design details to the RAG unit. The process 400 may include storing, by the RAG unit, the software architecture design details and the visual data insights in a first knowledge base (for example, the internal knowledge base 214), at step 324.

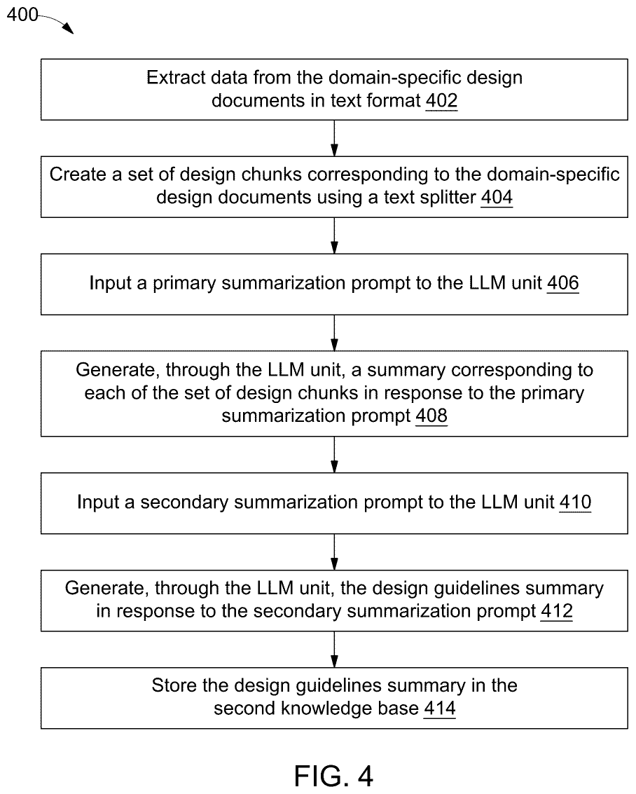

Referring now to FIG. 4, an exemplary process 400 for generating the design guidelines summary (for example, the design guidelines summary 232) is depicted via a flowchart, in accordance with some embodiments. FIG. 4 is explained in conjunction with FIGS. 1, 2, and 3. The process 400 may be implemented by the code generating device 102 of the system 100. The design guidelines summary may include coding standards, design patterns, best practices, and implementation strategies. Initially, domain-specific design documents (for example, the domain-specific design documents 250) may be received. To generate the design guidelines summary, the process 400 may include extracting, by a data extraction and processing unit (for example, the data extraction and processing unit 202), data from the domain-specific design documents (for example, the domain-specific design documents 250) in text format, at step 402. Further, the data extraction and processing unit may send the extracted data to the summarization unit (for example, the summarization unit 206). Further, the process 400 may include creating, by the summarization unit, a set of design chunks corresponding to the domain-specific design documents using a text splitter, at step 404. Further, the process 400 may include inputting, by the summarization unit, a primary summarization prompt to the LLM unit (for example, the first LLM unit 222), at step 406. The primary summarization prompt may include the set of design chunks and instructions corresponding to individual summary generation of each of the set of design chunks. Further, the process 400 may include generating, through the LLM unit, a summary corresponding to each of the set of design chunks in response to the primary summarization prompt, at step 408. Further, the process 400 may include inputting, by the summarization unit, a secondary summarization prompt to the LLM unit, at step 410. The secondary summarization prompt may include the summary, the set of design chunks, and instructions corresponding to generation of the design guidelines summary based on the summary. Further, the process 400 may include generating, through the LLM unit, the design guidelines summary in response to the secondary summarization prompt, at step 412. The design guidelines summary is a consolidated summary based on the summary for each of the set of design chunks. The LLM unit may send the design guideline summary to the summarization unit. Further, the process 400 may include storing, by the summarization unit, the design guidelines summary in the second knowledge base (for example, the external knowledge base 212), at step 414.

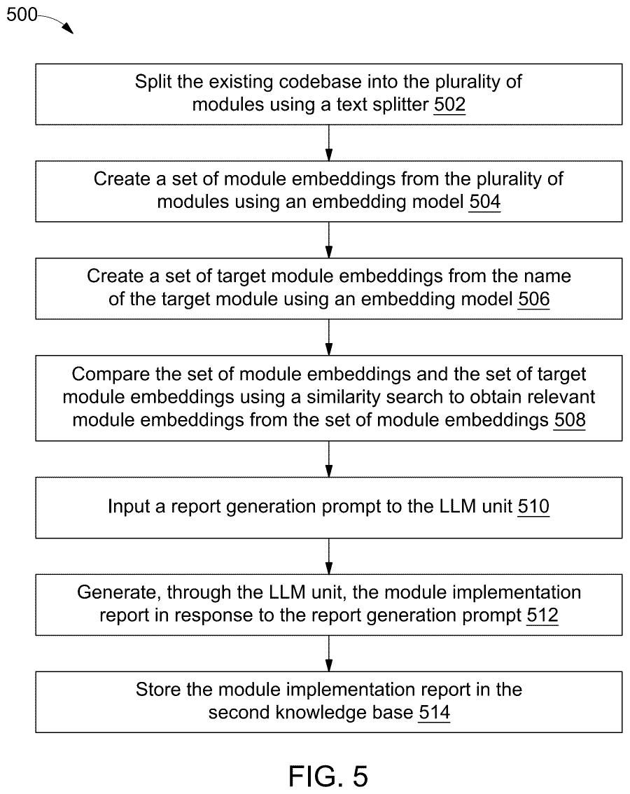

Referring now to FIG. 5, an exemplary process 500 for generating the module implementation report (for example, the module implementation report 234) is depicted via a flowchart, in accordance with some embodiments. FIG. 5 is explained in conjunction with FIGS. 1, 2, 3, and 4. The process 500 may be implemented by the code generating device 102 of the system 100. The module implementation report may include core functionalities and implementation details of the target module. Initially, an existing codebase (for example, the codebase 218) of a software may be received. To generate the module implementation report, the process 500 may include splitting, by the code RAG unit (for example, the code RAG unit 208), the existing codebase into the plurality of modules using a text splitter, at step 502. Further, process 500 may include creating, by the code RAG unit, a set of module embeddings from the plurality of modules using an embedding model, at step 504. Further, process 500 may include creating, by the code RAG unit, a set of target module embeddings from the name of the target module using an embedding model, at step 506. Further, process 500 may include comparing, by the code RAG unit, the set of module embeddings and the set of target module embeddings using a similarity search to obtain relevant module embeddings from the set of module embeddings, at step 508. The code RAG unit may be stored in the first vector database (for example, the first vector database 226). Further, the process 500 may include inputting, by the code RAG unit, a report generation prompt to the LLM unit (for example, the second LLM unit 224), at step 510. The report generation prompt may include the relevant module embeddings (context) and instructions corresponding to generation of the module implementation report. The process 500 may include generating, through the LLM unit, the module implementation report in response to the report generation prompt, at step 512. The LLM unit may send the module implementation report to the code RAG unit. The process 500 may include storing, by the code RAG unit, the module implementation report in the second knowledge base (for example, the external knowledge base 212), at step 514.

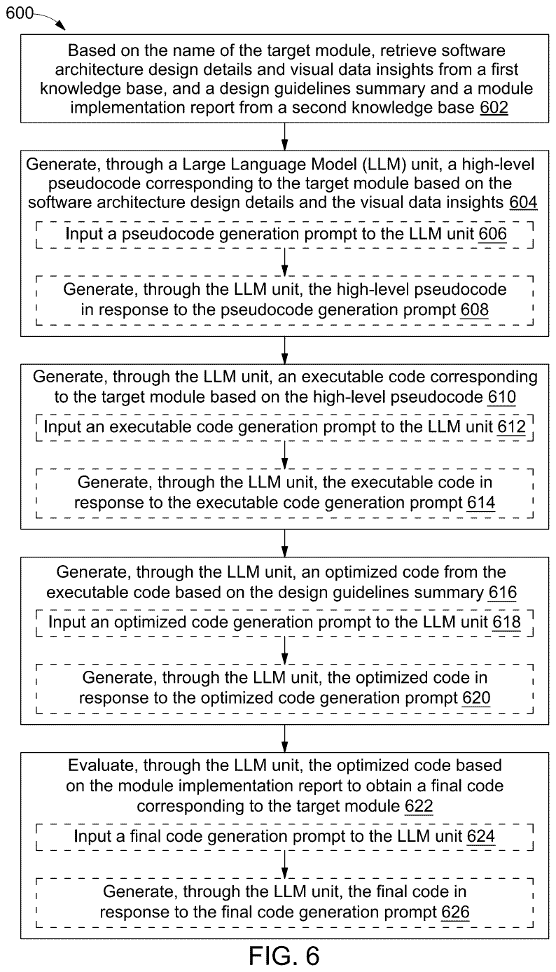

Referring now to FIG. 6, an exemplary process 600 for multi-agent based code generation is depicted via a flowchart, in accordance with some embodiments. FIG. 6 is explained in conjunction with FIGS. 1, 2, 3, 4, and 5. The process 600 may be implemented by the code generating device 102 of the system 100. Initially, a name of a target module may be received from a UI. The target module is one of a plurality of modules of the software in an existing codebase (for example, the codebase 218). Based on the name of the target module, the process 600 may include retrieving, by the data extraction and processing unit, software architecture design details and visual data insights from a first knowledge base (for example, the internal knowledge base 214), and a design guidelines summary and a module implementation report from a second knowledge base (for example, the external knowledge base 212), at step 602. It should be noted that the first knowledge base is a vector database based on software architecture design documents (for example, the software architecture design documents 248). The second knowledge base is a vector database based on domain-specific design documents (for example, the domain specific design documents 250) and the existing codebase.

Further, the process 600 may include generating, by a pseudocode builder agent (for example, the pseudocode builder agent 240) through a LLM unit (for example, the LLM unit 254), a high-level pseudocode corresponding to the target module based on the software architecture design details (for example, the software architecture design details 236) and the visual data insights, at step 604. The step 604 may include step 606 and step 608. The process 600 may include inputting, by the pseudocode builder agent, a pseudocode generation prompt to the LLM unit, at step 606. The pseudocode generation prompt may include the software architecture design details and instructions corresponding to generation of the high-level pseudocode. Further, the process 600 may include generating, through the LLM unit, the high-level pseudocode in response to the pseudocode generation prompt, at step 608.

Further, the process 600 may include generating, by a code generator agent (for example, the code generator agent 242) through the LLM unit, an executable code corresponding to the target module based on the high-level pseudocode, at step 610. The step 610 may include 612 and step 614. The process 600 may include inputting, by the code generator agent, an executable code generation prompt to the LLM unit, at step 612. The executable code generation prompt may include the high-level pseudocode and instructions corresponding to generation of the executable code. Further, the process 600 may include generating, through the LLM unit, the executable code in response to the executable code generation prompt, at step 614.

Further, the process 600 may include generating, by a code optimizer agent (for example, the code optimizer agent 244) through the LLM unit, an optimized code from the executable code based on the design guidelines summary (for example, the design guidelines summary 232), at step 616. The step 616 may include step 616, and step 618. The process 600 may include inputting, by the code optimizer agent, an optimized code generation prompt to the LLM unit, at step 616. The optimized code generation prompt may include the executable code, the design guidelines summary, and instructions corresponding to generation of the optimized code. Further, the process 600 may include generating, through the LLM unit, the optimized code in response to the optimized code generation prompt, at step 620. Further, the process 600 may include reviewing, by a code reviewer agent (for example, the code reviewer agent 246) through the LLM unit, the optimized code based on the module implementation report (for example, the module implementation report 234) to obtain a final code corresponding to the target module, at step 622. The step 622 may include step 624 and step 626. The process 600 may include inputting, by the code reviewer agent, generation prompt to the LLM unit, at step 624. The final code generation prompt may include the optimized code, the module implementation report, and instructions corresponding to generation of the final code. Further, the process 600 may include generating, by the LLM unit, the final code in response to the final code generation prompt, at step 626. The final code may be stored in a codebase (for example, the codebase 218).

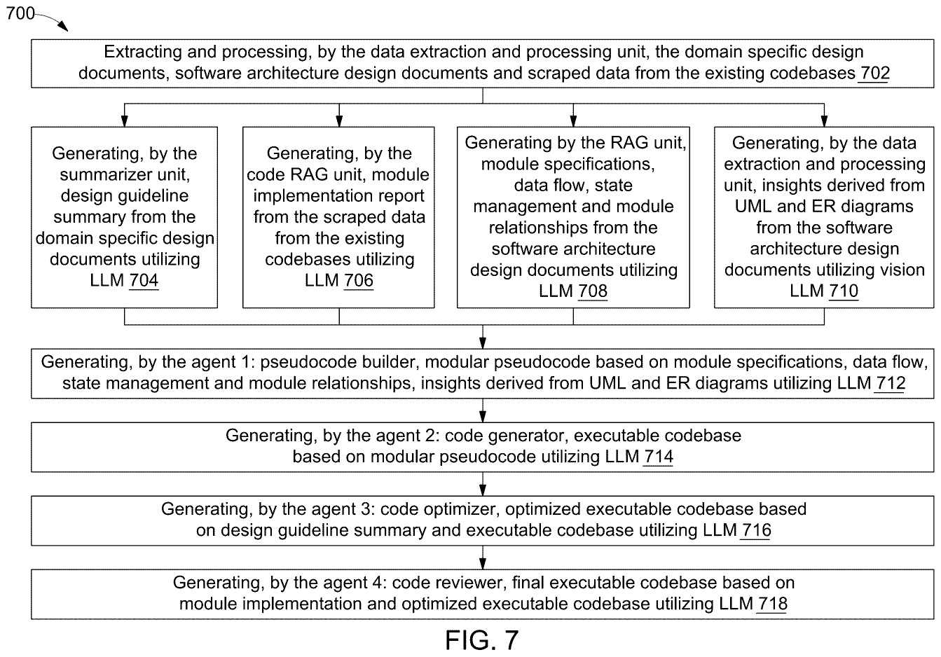

Referring now to FIG. 7, a detailed exemplary process 700 for multi-agent based code generation is depicted via a flowchart, in accordance with some embodiments. FIG. 7 is explained in conjunction with FIGS. 1, 2, 3, 4, 5, and 6. The process 700 may be implemented by the code generating device 102 of the system 100. The process 700 may include extracting and processing, by the data extraction and processing unit 202, a name of a target module from a UI, the software architecture design documents 248, the domain-specific design document 250, and existing codebase 252 sent by a user through the UI, at step 702. The name of the target module may be one for which the code is to be generated. The data extraction and processing unit 202 may process the domain specific design documents 250, the software architecture design documents 248 and links to the existing codebases 252. The text data may be extracted from the domain-specific design document 250 and the software architecture design documents 248 by text parsing (for example, using Python text parsing libraries). Visual data (from UML/ER diagrams) may be extracted from the software architecture design documents 248 in image format using tools (for example, Python libraries such as PyPDF2, PyMuPDF, etc.). The visual data (or the image data) may be sent to the vision model 204. The vision model 204 may include an LLM unit inside an external LLM server. The LLM unit may convert the visual data into textual format to obtain visual data insights, and may further send the visual data insights to the data extraction and processing unit 202. The data extraction and processing unit 202 may send queries for scraping the data from the existing codebases 252 (through links to the existing codebases) to the Internet (various servers of the existing codebases 252). The data extraction and processing unit 202 may receive scraped data (Codebase) from the Internet (various servers of the existing codebases). The text corresponding to domain specific design documents 250 may be sent to the summarization unit 206 by the data extraction and processing unit 202. The data extraction and processing unit 202 may send scraped data (Codebase) to the code RAG Unit 208 along with the name of the target module to the code RAG unit 208. The data extraction and processing unit 202 may send the text corresponding to the software architecture design documents 248 and the text corresponding to the visual data (i.e., the visual data insights from UML/ER diagrams) extracted from the software architecture design documents to the RAG Unit 210.

Further, the process 700 may include generating, by the summarization unit 206 through the first LLM unit 222, the design guideline summary 232 from the domain specific design documents 250, at step 704. To generate the design guideline summary, the summarization unit 206 may receive text corresponding to the domain specific design documents 250 from the data extraction and processing unit 202. The text may be divided into manageable plurality of chunks using a text splitter (for example, using LangChain's text splitter where each chunk represents a document). Further, the summarization unit 206 may perform a map-reduce process on the plurality of chunks. The map-reduce process may be performed in two phases and may be implemented by using the summarization chain 220 (for example, LangChain's load_summarize_chain( ) function with chain_type set to map_reduce). The two phases to perform map-reduce may be map phase and reduce phase. To perform map phase, the summarization unit 206 may send each of the plurality of chunk of text to the first LLM unit 222 in a prompt with an instruction to generate summary with essential coding standards, design patterns, and best practices. An example of the prompt may be as follows.
“““Please summarize the following text: {text} by highlighting the key Coding Standards, Design Patterns, Implementation Strategies and Best Practices, and any other relevant insights that contribute to improving code quality. Focus on making the summary concise, clear, and actionable. Extract all the relevant guidelines that ensure consistent and high-quality coding standards, while omitting redundant or irrelevant information.”””

In the above example, the prompt {text} may contain the chunk. The first LLM Unit 222 may summarize each of the plurality of chunk capturing essential coding standards, design patterns, and best practices. The first LLM Unit 222 may send the summary back to the summarization unit 206. The map phase may be performed for each of the plurality of chunks and individual summaries corresponding to each of the plurality of chunk received from the first LLM unit 222. In an embodiment, the process of map phase may be performed serially or in parallel.

Further, to perform reduce phase, the summarization unit 206 may send the individual summaries corresponding to the plurality of chunks to the first LLM unit 222 in a prompt with an instruction to generate combined summary. An example of the prompt may be as follows.
“““Please combine the following summaries: {summary_list} into a unified and cohesive overview. The result should include the essential Coding Standards, Design Patterns, Best Practices and Implementation Strategies from all the summaries, without repeating any information. Ensure that the summary flows logically, captures the most important insights, and serves as a comprehensive reference for high-quality coding practices.”””

In the above example, the {summary_list} may contain the combined individual summaries interchangeably known as “the design guideline summary 232” obtained in the map phase. The design guideline summary 232 may include essential coding standards, design patterns, and best practices. The first LLM unit 222 may combine the summaries into a single cohesive overview. The single cohesive overview may consolidate key insights without redundancy. The first LLM unit 222 may send the combined the design guidelines summary 232 to the summarization unit 206. The summarization unit 206 may store the design guideline summary 232 in the external knowledge base 212 in a text file. Further, the summarization unit 206 may send the signal to the pseudocode builder agent 240 about the completion of the generation of the design guideline summary 232.

Further, the process 700 may include generating, by the code RAG unit 208 through the second LLM unit 224, the module implementation report 234 from the scraped data from the existing codebase 252, at step 706. The code RAG unit 208 may receive scraped data (Codebase) and name of the target module from the data extraction and processing unit 202. The codebase may be parsed using file loader packages for example, using GenericLoader function from langchain_community.document_loaders.generic package and LanguageParser function from langchain_community.document_loaders.parsers package. The codebase may be split into modules using context aware splitting using text splitter package. For example, RecursiveCharacterTextSplitter function from langchain_text_splitters package with language of the code specified as a parameter. The code RAG unit 208 may create embeddings corresponding to the documents and stores the embeddings in first vector database 226. Based on the embeddings corresponding to the name of the target module (query) provided by the user, the relevant code is filtered from the first vector database 226 using similarity search. The filtered code placed inside a prompt along with the instructions to generate core functionalities along with the implementation details of the module may be sent to the second LLM unit 224. An example of the prompt may be as follows.
“““Given the following filtered code: {code} related to the module: {target_module_name}, please generate a detailed report that covers the following aspects:
Core Functionalities: Identify and describe the main functionalities of the module. Explain how each function or class serves its purpose within the module and its interaction with other parts of the codebase.
Implementation Details: Provide an in-depth explanation of the implementation of the core functionalities. Include important coding patterns, logic, libraries, and design choices used in the module. Highlight any complex or crucial sections of the code and explain their significance.
Additional Considerations: Mention any additional considerations, such as performance optimizations, edge cases, or future enhancements that should be kept in mind when developing or maintaining the module.
Please ensure that the report is clear, well-structured, and provides comprehensive insights into the module's implementation. Include examples from the code where necessary to illustrate your explanations.”””

In the above example of the prompt, {code} may be the filtered code obtained from the first vector database 226 corresponding to the target module and {target_module_name} may be the name of the target module.

Further, the second LLM unit 224 may generate a detailed report on the core functionalities of the module, including the implementation details. The second LLM unit 224 may send the report to the code RAG Unit 208. The code RAG Unit 208 may save the report in a file named module implementation report 234 inside the external knowledge base 212. Further the code RAG unit 208 may send the signal to the pseudocode builder agent 240 about the completion of the generation of the module implementation report 234.

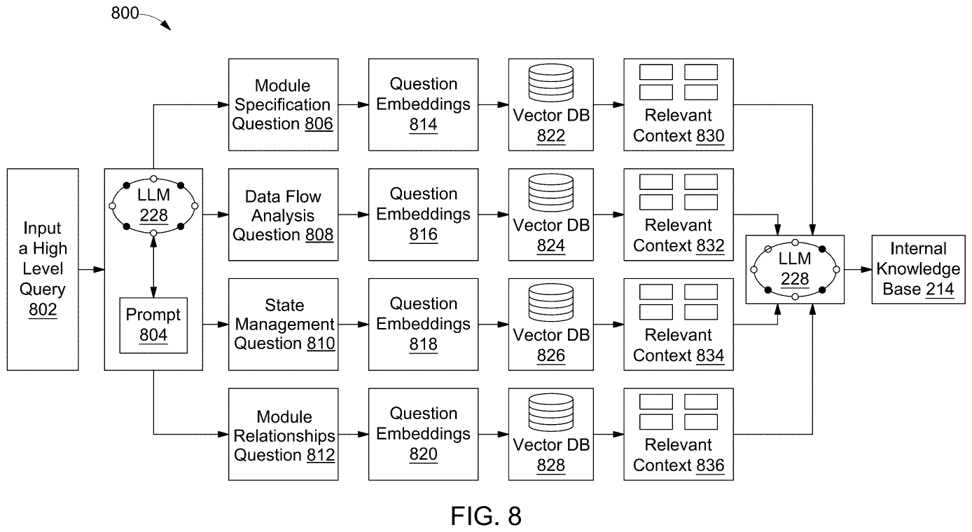

Further, the process 700 may include generating, by the RAG unit 210 through the third LLM 228, the software architecture design details 236 from the software architecture design documents 248, at step 708. The generating of the software architecture design details is explained in greater detail in conjunction with FIG. 8. The software architecture design documents 248 may include module specifications, data flow, state management and module relationships. To generate the software architecture design details 236, the RAG unit 210 may receive text corresponding to the software architecture design documents 248 and the text corresponding to the visual data (from UML/ER diagrams) extracted from software architecture design documents 248 from the data extraction and processing unit 202. The received text may be organized into coherent, manageable plurality of chunks using text splitter package (for example, using RecursiveCharacterTextSplitter function from langchain_text_splitters package). The chunks may be then converted into embeddings using an embedding model (for example, using Amazon Titan may captures the semantic meaning of the text, enabling context-aware search). The RAG unit 210 may store the embeddings in the second vector database 230 for an efficient similarity-based retrieval. The RAG Unit 210 may divide the text received from data extraction and processing unit 202 into manageable plurality of chunks. Each of the plurality chunks may represent a document, using text splitter package (for example, using LangChain's text splitter). Further, a map-reduce process may be performed on the plurality of chunks. The map-reduce process may be performed in two phases and may be implemented by using LangChain's load_summarize_chain( ) function with chain_type set to map_reduce.

In map phase process, each of the plurality of chunks of text may be sent to the third LLM Unit 228 in a prompt with an instruction to generate concise summary for each chunk. An example of the prompt may be as follows.
“““Please generate a concise summary for the following text: {text} Focus on extracting the key insights, coding patterns, design elements, and any other relevant details that are important for understanding the software architecture. The summary should be clear, precise, and focus on capturing the essential components of the design, without going into unnecessary detail. Please ensure that the summary is actionable and highlights the core architectural concepts and relationships described in the provided text.”””

In the above example, the “{text}” may contain the chunk. Further, the third LLM Unit 228 may send the summary back to the RAG Unit 210. The map phase is performed for each of the plurality of chunk and further individual summaries corresponding to each of the plurality of chunks may be received from the third LLM Unit 228. In an embodiment, the map phase process may be performed serially or in parallel.

In reduce phase process, the individual summaries corresponding to chunks may be sent to the third LLM Unit 228 by the RAG Unit 210 in a prompt with an instruction to generate combined summary. An example of the prompt may be as follows.
“““Please combine the following individual summaries: {summary_list} into one cohesive overview. The combined summary should encapsulate the key insights and concepts from all the provided summaries, while eliminating redundancy. Ensure that the summary highlights the most important aspects of the software architecture, including the relationships, components, and design patterns, in a clear and logical flow. The result should be a comprehensive overview that captures the essence of the entire document while maintaining clarity and focus on the key architectural elements.”””

In the above example, the {summary_list} may contain the combines individual summaries obtained in the map phase process. The third LLM Unit 228 may combine the summaries into a single, cohesive overview consolidating key insights without redundancy. The third LLM Unit 228 may send the combined summary to the RAG Unit 210.

The RAG Unit 210 may prepare a prompt including the combined summary and instructions to generate comprehensive module specifications, data flow dependencies, state management protocols and module relationships. An example of the prompt may be as follows
“““Please generate a detailed response for the following query using the example format below. You are required to break down the task into different components: Module Specifications, Data Flow Dependencies, State Management Protocols, and Module Relationships. For each component, provide an explanation with the relevant details. The combined summary of the domain will be used to inform and guide the creation of each section.
Input:
Combined Summary: {Summary}
Query: Generate comprehensive Module Specifications, define Data Flow Dependencies, establish State Management Protocols, identify Module Relationships to support automated code generation task. By way of an example, in JSON format, the input may be:
   Example JSON format:
   {
   “Module Specifications”: {
   “Description”: “Details about the module specification go here, including the core functionality, interfaces, performance requirements, security constraints, and error handling mechanisms.”
   },
   “Interface Specifications”: {
   “Description”: “Details about the interface specifications, such as input/output formats, communication protocols, and the way external modules interact with the module.”
   }
   “Data Flow Dependencies”: {
   “Description”: “Details about how data moves through the system, including data structures, validation rules, transformation logic, input/output formats, and data lifecycle management.”
   }
   “State Management Protocols”: {
   “Description”: “Explanation of how the module manages its state, including state definitions, transition rules, persistence strategies, concurrency handling, and recovery procedures.”
   }
   “Module Relationships”: {
   “Description”: “Details on the relationships between the module and other modules or systems, such as dependency mapping, interface contracts, communication patterns, version compatibility, and integration points.”
   }
   }

The RAG Unit 210 may also provide instructions to break down comprehensive module specifications, data flow dependencies, state management protocols and module relationships into individual components with specific details of each component. In continuation of the above example, the instruction may include
“Instructions:
Module Specifications: Provide a comprehensive explanation of the core functionalities, performance requirements, security constraints, error handling mechanisms, and any other essential details specific to the module.
Data Flow Dependencies: Describe the flow of data through the module, including structures, validation rules, transformation logic, and lifecycle management.
State Management Protocols: Explain the state definitions, transition rules, persistence strategies, and recovery mechanisms for handling state within the module.
Module Relationships: Outline the relationships between the module and others, including dependencies, integration points, version compatibility, and communication patterns. The response should be structured in the JSON format provided with clear and concise details for each section. Ensure that each part is aligned with the instructions provided.””

In the above example, the {Summary} may contain the combined summary. The specific details of the module specifications may include core functionality, interface definitions, performance requirements, security constraints, and error handling. The specific details of the data flow dependencies may include data structures, validation rules, transformation logic, input/output formats, and data lifecycle. The specific details of the state management protocols may include state definitions, transition rules, persistence strategy, concurrency handling, and recovery procedures. The specific details of the module relationships may include dependencies mapping, interface contracts, communication patterns, version compatibility, and integration points.

Further, the RAG unit 210 may send the prompt to the third LLM unit 228 to generate the response in a JSON format. The response may be received from the third LLM Unit 228 in the JSON format. Each of the individual components (response) in JSON format may be converted into embeddings using embedding model (for example, Amazon Titan). The embeddings corresponding to the individual components (query) may be used to retrieve relevant context for the individual component using similarity search from the second vector database 230. The retrieved relevant contexts for the individual components may be provided inside individual prompts with instructions to provide essential details about module specifications, data flow dependencies, state management protocols and module relationships may be sent to the third LLM Unit 228. An example of the module specifications prompt may be as follows.

“““Using the given context: {text} please generate detailed information for the Module Specifications section. The focus should be on the following areas, providing specific details for each:
Core Functionality: Describe the primary function of the module, the key features it provides, and its purpose within the overall system. How does it interact with other modules and what is its role in the system architecture?
Interface Definitions: List and describe the input/output interfaces for the module. Include details about communication protocols, expected data formats (e.g., JSON, XML), and the methods used to interact with other modules or systems.
Performance Requirements: Specify any performance metrics for the module. This can include response time, throughput, memory usage, and scalability requirements.
Security Constraints: Provide details on the security considerations that must be implemented within the module, such as authentication, authorization, data encryption, and secure communication.
Error Handling: Outline the error handling mechanisms for the module, including how errors are detected, logged, and managed. Describe any retry strategies, fallbacks, or notifications in case of failures.
Ensure that each part is well-defined and provides a clear description that will support automated code generation.”””

In the above prompt, {text} may contain the retrieved relevant contexts. An example of the data flow dependencies prompt may be as follows.
“““Using the given context: {text}, please generate detailed information for the Data Flow Dependencies section. The focus should be on the following areas, providing specific details for each:
Data Structures: Describe the data structures used by the module, including types, fields, and relationships. How is data represented and processed?
Validation Rules: Define the validation rules applied to the data at various stages, including input validation, transformation checks, and output validation.
Transformation Logic: Provide the logic used to transform the data. Include any mapping, conversion, or processing rules.
Input/Output Formats: Specify the formats in which data is expected for input and output, including any specific formats like JSON, XML, CSV, etc.
Data Lifecycle: Explain how data is managed throughout its lifecycle, from creation and modification to deletion. Detail any caching, persistence, or archiving strategies.
Ensure that the response is clear and covers the entire data flow within the module.”””

In the above prompt, {text} may contain the retrieved relevant contexts. An example of the state management protocols may be as follows.
“““Using the given context: {text}, please generate detailed information for the State Management Protocols section. The focus should be on the following areas, providing specific details for each:
State Definitions: Define the states that the module can be in, including initial, intermediate, and final states. What are the criteria for each state?
Transition Rules: Describe the rules that govern transitions between states. What triggers state transitions, and what conditions need to be met for a transition to occur?
Persistence Strategy: Explain how the state persisted, whether in a database, file system, or memory. What persistence mechanisms are used to store and retrieve state information?
Concurrency Handling: Describe how the module handles concurrency. Are there locks, transactions, or other mechanisms in place to ensure data integrity in concurrent environments?
Recovery Procedures: Provide details on recovery procedures for state management. How does the module handle system failures, crashes, or restarts to ensure the integrity of its state?
Ensure that the response clearly covers each aspect of state management within the module.”””

In the above prompt, {text} may contain the retrieved relevant contexts. An example of the module relationship prompt may be as follows.
“““Using the given context: {text} of the domain, please generate detailed information for the Module Relationships section. The focus should be on the following areas, providing specific details for each:
Dependencies Mapping: Map the dependencies between the module and other modules or services. What external systems or components does the module depend on, and what are the types of these dependencies (e.g., libraries, APIs)?
Interface Contracts: Define the interface contracts between the module and other modules, including method signatures, expected input/output, and any protocols used.
Communication Patterns: Describe how the module communicates with other modules. Are communications synchronous or asynchronous? What messaging patterns are used?
Version Compatibility: Explain how the module handles version compatibility with other modules. Are there any versioning strategies in place, such as semantic versioning or backward compatibility?
Integration Points: Identify the integration points where the module connects with external systems, including APIs, message queues, or other data exchange mechanisms.
Ensure that the response clearly describes the relationships between the module and other components.”””

In the above prompt, {text} contains the retrieved relevant contexts. The third LLM unit 228 may generate responses (i.e. for module specifications, data flow, state management and module relationships) and send the responses to the RAG Unit 210. The RAG unit 210 may consolidate and save the responses in one text file inside internal knowledge base 214. Further, the RAG unit 210 may send signal to the pseudocode builder agent 240 about the completion of the generation of module specifications, data flow, state management and module relationships.

Further, the process 700 may include generating, by the data extraction and processing unit 202 through the LLM unit in the vision model 204, the set of visual data insights 238 derived from the UML and ER diagrams from the software architecture design documents 248, at step 710. To generate insights derived from the UML and ER diagrams, the data extraction and processing unit 202 may send the text corresponding to the visual data (i.e., the visual data insights from UML/ER diagrams) extracted from software architecture design documents to the internal knowledge base 214 for storage into a text file. The data extraction and processing unit 202 may send signal to the pseudocode builder agent 240 about the completion of the generation of the set of visual data insights 238 derived from UML and ER Diagrams.

Further, the process 700 may include generating, by the pseudocode builder agent 240, the high-level pseudocode corresponding to the target module based on the software architecture design details 236 and the visual data insights, at step 712. The pseudocode builder agent 240 may receive the signal from the summarizer unit 206 of the completion of the generation of the design guideline summary 232. The pseudocode builder agent 240 may receive the signal from the code RAG Unit 208 about the completion of the generation of module implementation report 234. The pseudocode builder agent 240 may receive the signal from the RAG Unit 210 of the completion about the generation of the software architecture design details 236. The pseudocode builder agent 240 may receive the signal from the data Extraction and processing unit 202 about the completion of the generation of the set of visual data insights 238 derived from UML and ER diagrams. The pseudocode builder agent 240 may fetch the software architecture design details 236 (i.e., the module specifications, data flow, state management and module relationships as well as the set of visual data insights 238 derived from UML and ER Diagrams) from the internal knowledge base 214. The pseudocode builder agent 240 may send the fetched module specifications, data flow, state management and module relationships as well as the set of visual data insights 238 derived from UML and ER Diagrams in a prompt with the instruction to generate high-level Pseudocode to the LLM Unit 254. An example of the prompt for the pseudocode builder agent 240 may be as follows.
“““The objective is to leverage the detailed insights from the Internal Knowledge Base given below, which encompasses module specifications, data flow protocols, state management mechanisms, and module relationships and Insights Derived from UML and ER Diagrams, to generate high-level pseudocode. The goal is to facilitate the design and development of the module by providing a structured, logical outline of its operations and interactions.
Input:
Internal Knowledge Base: {Internal_Knowledge_Base}
Instructions:
Utilizing the provided module-specific details, your task is to generate pseudocode that: Articulates the core functionalities of the module, defining its primary operations and responsibilities.
Constructs a clear flow of logic pathways, illustrating how components interact within the system.
Specifies the data flow mechanisms, including validation, transformation, and lifecycle management.
Defines state management protocols, including state transitions, persistence strategies, and concurrency handling.
Includes robust error handling procedures that ensure fault tolerance and recovery.
The pseudocode should be written in a modular, readable format that logically segments the various functionalities, ensuring ease of understanding and future development.
Output Structure:
The pseudocode should be logically organized, with each section representing a distinct module component or functionality.
Ensure clarity and conciseness in describing complex logic, maintaining modularity to facilitate scalable development.”””

In the above prompt, {Internal_Knowledge_Base}=module specifications, data flow, state management and module relationships and insights derived from UML and ER Diagrams. The LLM Unit 254 may generate the high-level pseudocode based on the module specifications, the data flow, state management and module relationships as well as the set of visual data insights 238 derived from UML and ER Diagrams. The LLM Unit 254 may send the high-level pseudocode to the pseudocode builder agent 240. The pseudocode builder agent 240 may send the high-level pseudocode to the code generator agent 242.

Further, the process 700 may include generating, by the code generator agent 242 through the LLM Unit 254, an executable code corresponding to the target module based on the high-level pseudocode, at step 714. The code generator agent 242 may receive the high-level pseudocode from the pseudocode builder agent 240. The code generator agent 242 may send the high-level Pseudocode inside a prompt with the instruction to translate the high-level pseudocode into the executable codebase to the LLM Unit 254. An example of the prompt for the code generator agent 242 may be as follows.
“““Your task is to convert high-level pseudocode given below, generated by first Agent, into a fully executable codebase. The pseudocode encapsulates the system's core logic, data flow, control structures, and interactions between components. Your responsibility is to translate this pseudocode into efficient, functional code while preserving the integrity of the design outlined in the original pseudocode.
Input:
pseudocode: {pseudocode}
Instructions:
The Pseudocode generated by first Agent, which includes high-level system logic, data structures, control flow, and interactions between components.
Task:
Data Types Implementation: Accurately translate the abstract data types described in the pseudocode into concrete, language-specific data structures (e.g., integers, arrays, classes, etc.).
Control Structures: Implement the specified control structures (e.g., conditionals, loops, and exception handling) in accordance with the pseudocode logic.
Module Interactions: Ensure that the interactions between different modules and components are faithfully implemented, as per the specified logic in the pseudocode.
Functionality Mapping: Ensure that all functions, algorithms, and operational logic described in the pseudocode are correctly translated into executable code.
Design Fidelity: Maintain design consistency by adhering to the intended flow, logic, and structure defined in the pseudocode, ensuring modularity and scalability.
Output:
The generated code should be syntactically correct, modular, and efficient. It should follow the structure laid out in the pseudocode, ensuring all functional requirements are met.”””

In the above prompt, {pseudocode} may contain the pseudocode generated by the pseudocode builder agent 240. The LLM Unit 254 may generate the executable codebase based on the high-level pseudocode. Further, the LLM Unit 254 may send the executable code to the code generator agent 242. The code generator agent 242 may send the executable code to the code optimizer agent 244.

The process 700 may include generating, by the code optimizer agent 244 through the LLM Unit 254, an optimized code from the executable code based on the design guidelines summary 232, at step 716. The code optimizer agent 244 may receive the executable codebase from the code generator agent 242. The code optimizer agent 244 may fetch the design guideline summary 232 from the external knowledge base 212. The design guideline summary 232 may include best practices, recommended design patterns, and domain-specific standards. The code optimizer agent 244 may send the executable codebase and the design guideline summary 232 inside a prompt with the instructions to generate optimized code to the LLM Unit 254. An example of the prompt for the code optimizer agent 244 may be as follows.
“““Your task is to optimize the codebase given below, generated by second agent, leveraging the Design Guidelines Summary given below as your reference. This summary encompasses comprehensive design principles, domain-specific best practices, and coding standards. Your objective is to refine the code, ensuring it aligns with these guidelines while enhancing its efficiency, clarity, and overall quality.
Input:
codebase: {codebase}, Design Guidelines Summary: {Summary}
Instructions:
The Generated Codebase from second Agent, which requires optimization.
The Design Guidelines Summary, a document outlining best practices, design patterns, and domain-specific standards.
Task:
Examine and Analyze the codebase for compliance with the established design standards.
Optimize Data Structures: Assess the current data structures for efficiency and refactor where necessary to improve performance and memory utilization.
Enhance Readability: Refine the code for clarity and maintainability, ensuring consistent naming conventions, modularity, and proper documentation.
Refactor Design Patterns: Review the application of design patterns, ensuring that the codebase implements suitable patterns to promote scalability, flexibility, and maintainability.
Performance Refinement: Identify potential performance bottlenecks and optimize critical code sections, ensuring both speed and scalability.
Align with Domain Standards: Ensure that the code adheres to domain-specific practices, as specified in the Design Guidelines Summary, for consistency and correctness within the broader system architecture.
Output:
A thoroughly optimized codebase that is syntactically refined, efficient, and fully aligned with the design principles outlined in the Design Guidelines Summary. The code should exhibit enhanced performance, readability, and adherence to best practices and domain-specific standards.”””

In the above prompt, {codebase} may contain the executable Code and {Summary} may contain the design guidelines summary 232. The LLM Unit 254 may generate the optimized Code based on the executable Code and the design guidelines summary 232. The LLM Unit 254 may send the optimized Code to the code optimizer agent 244. The code optimizer agent 244 may send the optimized code to the code reviewer agent 246.

Further, the process 700 may include generating, by the code reviewer agent 246 through the LLM Unit 254, a final code corresponding to the target module, at step 718. The code reviewer agent 246 may receive the optimized code from the code optimizer agent 244. The code reviewer agent 246 may send the optimized code and the module implementation text in a prompt with instructions to generate final code to the LLM Unit 254. An example of the prompt for the code reviewer agent 246 may be as follows.
“““You are tasked with reviewing the optimized code given below, produced by third Agent, in conjunction with the Module Implementation file given below, which contains detailed descriptions of the core functionalities and implementation specifics from previously developed code for the same module. Your role is to thoroughly evaluate the code to ensure that it accurately implements all required functionalities, as well as any additional features specified, and aligns with the previously established module architecture.
Input:
optimized code: {Code}, Module Implementation: {Module_Implementation}
Instructions:
Optimized Code from third Agent, which has undergone initial optimization.
Module Implementation file, detailing the core functionalities, implementation specifics, and any additional features or considerations for the module.
Task:
Evaluate Core Functionalities: Using the Module Implementation file as a reference, assess the optimized code to ensure that all critical functionalities are correctly implemented, as per the module's specifications.
Verify Completeness: Cross-reference the auto-generated code with the insights in the Module Implementation file to confirm that all essential concepts, features, and edge cases are covered.
Identify Missing Functionalities: If any fundamental or additional functionalities are absent or inaccurately implemented, propose improvements and incorporate them into the codebase.
Ensure Alignment: Ensure that the updated code aligns with both the overall system architecture and the specific implementation requirements outlined in the Module Implementation file.
Quality Assurance: Perform a thorough review to ensure the code is logically sound, efficient, and consistent with best practices for modularity, scalability, and maintainability.
Output:
A final updated codebase, enriched with any missing functionalities and improvements based on the Module Implementation reference. The updated code should be saved in the project directory, ready for further testing and integration.”””

In the above prompt, {Code} may contain the optimized code and {Module_Implementation} may contain the module implementation text. The LLM Unit 254 may generate the final code based on the optimized code and module implementation text. The LLM Unit 254 may send the final code to the code reviewer agent 246. The code reviewer agent 246 may send the final code to the codebase 218 for storage.

Referring now to FIG. 8, a block diagram of an exemplary process 800 for creating internal knowledge base 214 from the software architecture design documents 248 is illustrated, in accordance with an embodiment. FIG. 8 is explained in conjunction with FIGS. 1-8. The process 800 may be implemented by the code generating device 102 of the system 100. First, text and visual data (from UML/ER diagrams) are extracted from input documents using Python text parsing libraries along with vision models (such as the vision model 204) to interpret the diagrams. The extracted information is organized into coherent, manageable chunks. These chunks are then converted into embeddings that capture the semantic meaning of the text, enabling context-aware search. Finally, the embeddings are stored in a document vector database for efficient, similarity-based retrieval.

Further, the process 800 may include inputting, by the RAG unit 210, a high level query to the third LLM unit 228, at step 802. The high level query may be embedded in the code. The high level query may be, for example, “Generate comprehensive module specifications, defining data flow dependencies, establishing state management protocols, and additionally identifying inter-module relationships to support automated code generation”.

Further, the process 800 may include, receiving, by the third LLM unit 228, the software architecture design documents 248. Using a prompt 804 (i.e., a structured prompt), the LLM unit 228 breaks down the high level query into individual, specific questions. The prompt 804 may be based on the software architecture design documents 248. The questions may include a module specification question 806, a data flow analysis question 808, a state management question 810, and a module relationships question 812.

Focus areas of the module specification question 806 may include core functionalities, interface definitions, performance requirements, security constraints, and error handling. Focus areas of the data flow analysis question 808 may include data structures, validation rules, transformation logic, input/output formats, and the data life cycle. Focus areas of the state management question 810 may include state definitions, transition rules, persistence strategy, concurrency handling, and recovery procedures. Focus areas of the module relationships question 812 may include dependencies mapping, interface contracts, communication patterns, version compatibility, and integration points. Further, the process 800 may include creating, by the third LLM unit 228, question embeddings corresponding to each of the questions. Thus, the third LLM unit 228 may create question embeddings 814, question embeddings 816, question embeddings 818, and question embeddings 820 corresponding to the module specification question 806, the data flow analysis question 808, the state management question 810, and the module relationships question 812, respectively.

Further, the process 800 may include storing, by the third LLM unit 228, the question embeddings in a vector data base. The question embeddings 814, the question embeddings 816, the question embeddings 818, and the question embeddings 820 may be stored in a vector database 822, a vector database 824, a vector database 826, and a vector database 828, respectively. Further, the process 800 may include searching, by the LLM unit 228, in the document vector database for matching entries (or embeddings) for each of the question embeddings 814, the question embeddings 816, the question embeddings 818, and the question embeddings 820.

Based on the searching, the process 800 may include retrieving, by the LLM unit 228, relevant context corresponding to the question embeddings. A relevant context 830, a relevant context 832, a relevant context 834, and a relevant context 836 may be retrieved corresponding to the question embeddings 814, the question embeddings 816, the question embeddings 818, and the question embeddings 820, respectively. Further, the process 800 may include sending the retrieved relevant context to the third LLM unit 228. Further, the process 800 may include compiling, by the third LLM unit 228, the retrieved relevant context into the comprehensive and organized internal knowledge base 214. The internal knowledge base 214 may support code generation by providing essential specifications and dependency details to the pseudocode builder agent 240 and the code generator agent 242.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

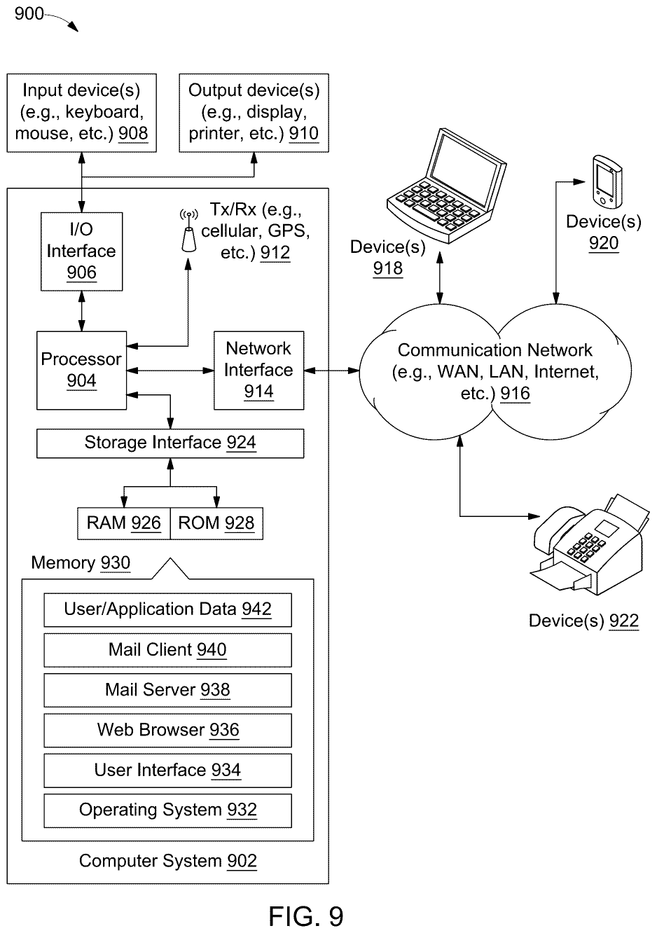

The disclosed methods and systems may be implemented on a conventional or a general-purpose computer system, such as a personal computer (PC) or server computer. Referring now to FIG. 9, an exemplary computing system 900 that may be employed to implement processing functionality for various embodiments (e.g., as a SIMD device, client device, server device, one or more processors, or the like) is illustrated. Variations of a computer system 902 may be used for implementing system 100 for advanced summarization of documents using topic intelligence-based Retrieval Augmented Generation (RAG). Computer system 902 may include a central processing unit (“CPU” or “processor”) 904. Processor 904 may include at least one data processor for executing program components for executing user-generated or system-generated requests. A user may include a person, a person using a device such as such as those included in this disclosure, or such a device itself. The processor 904 may include specialized processing units such as integrated system (bus) controllers, memory management control units, floating point units, graphics processing units, digital signal processing units, etc. The processor 904 may include a microprocessor, such as AMD® ATHLON®, DURON® OR OPTERON®, ARM's application, embedded or secure processors, IBM® POWERPC®, INTEL® CORE® processor, ITANIUM® processor, XEON® processor, CELERON® processor or other line of processors, etc. The processor 904 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc

Processor 904 may be disposed in communication with one or more input/output (I/O) devices via I/O interface 906. The I/O interface 906 may employ communication protocols/methods such as, without limitation, audio, analog, digital, monoaural, RCA, stereo, IEEE-1394, near field communication (NFC), FireWire®, Camera Link®, GigE®, serial bus, universal serial bus (USB), infrared, PS/2, BNC, coaxial, component, composite, digital visual interface (DVI), high-definition multimedia interface (HDMI®), radio frequency (RF) antennas, S-Video, video graphics Array® (VGA), IEEE® 902.n/b/g/n/x, Bluetooth®, cellular (e.g., code-division multiple access (CDMA), high-speed packet access (HSPA+), global system for mobile communications (GSM®), long-term evolution (LTE®), WiMAX®, or the like), etc.

Using the I/O interface 906, the computer system 902 may communicate with one or more I/O devices. For example, the input device 908 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, altimeter, gyroscope, proximity sensor, or the like), stylus, scanner, storage device, transceiver, video device/source, visors, etc. Output device 910 may be a printer, fax machine, video display (e.g., cathode ray tube (CRT), liquid crystal display (LCD), light-emitting diode (LED), plasma, or the like), audio speaker, etc. In some embodiments, a transceiver 912 may be disposed in connection with the processor 904. The transceiver 912 may facilitate various types of wireless transmission or reception. For example, the transceiver 912 may include an antenna operatively connected to a transceiver chip (e.g., TEXAS INSTRUMENTS® WILINK WL1286®, BROADCOM® BCM4550IUB8®, INFINEON TECHNOLOGIES® X-GOLD 618-PMB9800® transceiver, or the like), providing IEEE 802.11a/b/g/n, Bluetooth, FM, global positioning system (GPS), 2G/3G HSDPA/HSUPA communications, etc.

In some embodiments, the processor 904 may be disposed in communication with a communication network 916 via a network interface 914. The network interface 914 may communicate with the communication network 916. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 916 may include, without limitation, a direct interconnection, local area network (LAN), wide area network (WAN), wireless network (e.g., using Wireless Application Protocol), the Internet, etc. Using the network interface 914 and the communication network 916, the computer system 902 may communicate with devices 918, 920, and 922. These devices may include, without limitation, personal computer(s), server(s), fax machines, printers, scanners, various mobile devices such as cellular telephones, smartphones (e.g., APPLE® IPHONE®, BLACKBERRY® smartphone, ANDROID® based phones, etc.), tablet computers, eBook readers (AMAZON® KINDLE®, NOOK® etc.), laptop computers, notebooks, gaming consoles (MICROSOFT® XBOX®, NINTENDO® DS®, SONY® PLAYSTATION®, etc.), or the like. In some embodiments, the computer system 902 may itself embody one or more of these devices.

In some embodiments, the processor 904 may be disposed in communication with one or more memory devices 930 (e.g., RAM 926, ROM 928, etc.) via a storage interface 924. The storage interface 924 may connect to memory devices 930 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), STD Bus, RS-232, RS-422, RS-485, I2C, SPI, Microwire, 1-Wire, IEEE 1284, Intel® QuickPathInterconnect, InfiniBand, PCIe, etc. The memory drives may further include a drum, magnetic disc drive, magneto-optical drive, optical drive, redundant array of independent discs (RAID), solid-state memory devices, solid-state drives, etc.

The memory devices 930 may store a collection of program or database components, including, without limitation, an operating system 932, user interface 934, web browser 936, mail server 938, mail client 940, user/application data 942 (e.g., any data variables or data records discussed in this disclosure), etc. The operating system 932 may facilitate resource management and operation of the computer system 902. Examples of operating systems include, without limitation, APPLE® MACINTOSH® OS X, UNIX, Unix-like system distributions (e.g., Berkeley Software Distribution (BSD), FreeBSD, NetBSD, OpenBSD, etc.), Linux distributions (e.g., RED HAT®, UBUNTU®, KUBUNTU®, etc.), IBM® OS/2, MICROSOFT® WINDOWS® (XP®, Vista®/7/8, etc.), APPLE® IOS®, GOOGLE® ANDROID®, BLACKBERRY® OS, or the like. User interface 934 may facilitate display, execution, interaction, manipulation, or operation of program components through textual or graphical facilities. For example, user interfaces may provide computer interaction interface elements on a display system operatively connected to the computer system 902, such as cursors, icons, check boxes, menus, scrollers, windows, widgets, etc. Graphical user interfaces (GUIs) may be employed, including, without limitation, APPLE® MACINTOSH® operating systems' AQUA® platform, IBM® OS/2®, MICROSOFT® WINDOWS® (e.g., AERO®, METRO®, etc.), UNIX X-WINDOWS, web interface libraries (e.g., ACTIVEX®, JAVA®, JAVASCRIPT®, AJAX®, HTML, ADOBE® FLASH®, etc.), or the like.

In some embodiments, the computer system 902 may implement a web browser 936 stored program component. The web browser may be a hypertext viewing application, such as MICROSOFT® INTERNET EXPLORER®, GOOGLE® CHROME®, MOZILLA® FIREFOX®, APPLE® SAFARI®, etc. Secure web browsing may be provided using HTTPS (secure hypertext transport protocol), secure sockets layer (SSL), Transport Layer Security (TLS), etc. Web browsers may utilize facilities such as AJAX®, DHTML, ADOBE® FLASH®, JAVASCRIPT®, JAVA®, application programming interfaces (APIs), etc. In some embodiments, the computer system 902 may implement a mail server 938 stored program component. The mail server may be an Internet mail server such as MICROSOFT® EXCHANGE®, or the like. The mail server may utilize facilities such as ASP, ActiveX, ANSI C++/C#, MICROSOFT.NET® CGI scripts, JAVA®, JAVASCRIPT®, PERL®, PHP®, PYTHON®, WebObjects, etc. The mail server may utilize communication protocols such as internet message access protocol (IMAP), messaging application programming interface (MAPI), MICROSOFT® EXCHANGE®, post office protocol (POP), simple mail transfer protocol (SMTP), or the like. In some embodiments, the computer system 902 may implement a mail client 940 stored program component. The mail client may be a mail viewing application, such as APPLE MAIL®, MICROSOFT ENTOURAGE®, MICROSOFT OUTLOOK®, MOZILLA THUNDERBIRD®, etc.

In some embodiments, computer system 902 may store user/application data 942, such as the data, variables, records, etc. (e.g., vector databases, design guideline summary, module implementation report, software architecture design details, visual data insights, LLM data, and so forth) as described in this disclosure. Such databases may be implemented as fault-tolerant, relational, scalable, secure databases such as ORACLE® or SYBASE®. Alternatively, such databases may be implemented using standardized data structures, such as an array, hash, linked list, struct, structured text file (e.g., XML), table, or as object-oriented databases (e.g., using OBJECTSTORE®, POET®, ZOPE®, etc.). Such databases may be consolidated or distributed, sometimes among the various computer systems discussed above in this disclosure. It is to be understood that the structure and operation of the any computer or database component may be combined, consolidated, or distributed in any working combination.

Thus, the disclosed method and system try to overcome the technical problem of multi-agent based code generation. The disclosed method and system may receive a name of a target module from a User Interface (UI). The target module is one of a plurality of modules in an existing codebase. Based on the name of the target module, the disclosed method and system may further retrieve software architecture design details and visual data insights from a first knowledge base, and a design guidelines summary and a module implementation report from a second knowledge base. The first knowledge base is a vector database based on software architecture design documents. The second knowledge base is a vector database based on domain-specific design documents and the existing codebase. Further, the disclosed method and system may generate, through the LLM unit, a high-level pseudocode corresponding to the target module based on the software architecture design details and the visual data insights. Further, the disclosed method and system may generate, through the LLM unit, an executable code corresponding to the target module based on the high-level pseudocode. Further, the disclosed method and system may generate, through the LLM unit, an optimized code from the executable code based on the design guidelines summary. Further, the disclosed method and system may review, through the LLM unit, the optimized code based on the module implementation report to obtain a final code corresponding to the target module

As will be appreciated by those skilled in the art, the techniques described in the various embodiments discussed above are not routine, or conventional, or well understood in the art. The techniques may improve the quality of the code. The techniques may leverage specialized agents to handle a plurality of aspects of the code generation process, resulting in high-quality output. Further, the techniques may optimize the generated code to align with design and coding guidelines, enhancing overall code quality. Further, the techniques may perform an in-depth review to ensure the code covers expected standards and functionalities. The techniques may provide flexibility and scalability, allowing each of the multi-agent to be updated independently as needed. Further, the techniques may reduce manual coding efforts, and save valuable time. Further, the techniques may provide fully automated workflow, from the analysis of software requirements to code generation, optimization, and review.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system of multi-agent based code generation. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of multi-agent based code generation, the method comprising:
receiving, by a code generating device, a name of a target module from a User Interface (UI), wherein the target module is one of a plurality of modules in an existing codebase;
based on the name of the target module, retrieving, by the code generating device, software architecture design details and visual data insights from a first knowledge base, and a design guidelines summary and a module implementation report from a second knowledge base, wherein the first knowledge base is a vector database based on software architecture design documents, and wherein the second knowledge base is a vector database based on domain-specific design documents and the existing codebase;
generating, by the code generating device through a Large Language Model (LLM) unit, a high-level pseudocode corresponding to the target module based on the software architecture design details and the visual data insights;
generating, by the code generating device through the LLM unit, an executable code corresponding to the target module based on the high-level pseudocode;
generating, by the code generating device through the LLM unit, an optimized code from the executable code based on the design guidelines summary; and
reviewing, by the code generating device through the LLM unit, the optimized code based on the module implementation report to obtain a final code corresponding to the target module.

2. The method of claim 1, wherein:
the software architecture design details comprises module specifications, data flow, state management, and module relationships,
the design guidelines summary comprises coding standards, design patterns, best practices, and implementation strategies, and
the module implementation report comprises core functionalities and implementation details of the target module.

3. The method of claim 1, further comprising generating the software architecture design details, wherein the generating comprises:
extracting data and the visual data insights from the software architecture design documents in text format, wherein the data comprise text data and image data, and wherein the visual data insights are extracted through a vision LLM;
creating a first set of architecture chunks corresponding to the text data of the software architecture design documents using a text splitter; and
creating a first set of architecture embeddings based on the first set of architecture chunks using an embedding model.

4. The method of claim 3, wherein the generating further comprises:
inputting a primary details generation prompt to the LLM unit, wherein the primary details generation prompt comprises the first set of architecture embeddings and instructions corresponding to individual generation of primary software architecture design details;
generating, through the LLM unit, primary software architecture design details in response to the primary details generation prompt;
generating, through the LLM unit, an individual query corresponding to each of the primary software architecture design details from a high-level query using a structured prompt;
creating a second set of architecture embeddings based on the individual query using the embedding model;
comparing the second set of architecture embeddings and the first set of architecture embeddings using a similarity search to obtain relevant embeddings from the first set of architecture embeddings;
inputting a secondary details generation prompt to the LLM unit, wherein the secondary details generation prompt comprises the relevant embeddings and instructions corresponding to individual generation of the software architecture design details;
generating, through the LLM unit, the software architecture design details in response to the secondary details generation prompt; and
storing the software architecture design details and the visual data insights in the first knowledge base.

5. The method of claim 1, further comprising generating the design guidelines summary, wherein the generating comprises:
extracting data from the domain-specific design documents in text format;
creating a set of design chunks corresponding to the domain-specific design documents using a text splitter;
inputting a primary summarization prompt to the LLM unit, wherein the primary summarization prompt comprises the set of design chunks and instructions corresponding to individual summary generation of each of the set of design chunks;
generating, through the LLM unit, a summary corresponding to each of the set of design chunks in response to the primary summarization prompt;
inputting a secondary summarization prompt to the LLM unit, wherein the secondary summarization prompt comprises the summary and instructions corresponding to generation of the design guidelines summary based on the summary;
generating, through the LLM unit, the design guidelines summary in response to the secondary summarization prompt, wherein the design guidelines summary is a consolidated summary based on the summary for each of the set of design chunks; and
storing the design guidelines summary in the second knowledge base.

6. The method of claim 1, further comprising generating the module implementation report, wherein the generating comprises:
splitting the existing codebase into the plurality of modules using a text splitter;
creating a set of module embeddings from the plurality of modules using an embedding model;
creating a set of target module embeddings from the name of the target module using an embedding model;
comparing the set of module embeddings and the set of target module embeddings using a similarity search to obtain relevant module embeddings from the set of module embeddings;
inputting a report generation prompt to the LLM unit, wherein the report generation prompt comprises the relevant module embeddings and instructions corresponding to generation of the module implementation report;
generating, through the LLM unit, the module implementation report in response to the report generation prompt; and
storing the module implementation report in the second knowledge base.

7. The method of claim 1, wherein generating the high-level pseudocode comprises:
inputting a pseudocode generation prompt to the LLM unit, wherein the pseudocode generation prompt comprises the software architecture design details and instructions corresponding to generation of the high-level pseudocode; and
generating, through the LLM unit, the high-level pseudocode in response to the pseudocode generation prompt.

8. The method of claim 1, wherein generating the executable code corresponding to the target module comprises:
inputting an executable code generation prompt to the LLM unit, wherein the executable code generation prompt comprises the high-level pseudocode and instructions corresponding to generation of the executable code; and
generating, through the LLM unit, the executable code in response to the executable code generation prompt.

9. The method of claim 1, wherein generating the optimized code from the executable code comprises:
inputting an optimized code generation prompt to the LLM unit, wherein the optimized code generation prompt comprises the executable code, the design guidelines summary, and instructions corresponding to generation of the optimized code; and
generating, through the LLM unit, the optimized code in response to the optimized code generation prompt.

10. The method of claim 1, wherein reviewing the optimized code based on the module implementation report comprises:
inputting a final code generation prompt to the LLM unit, wherein the final code generation prompt comprises the optimized code, the module implementation report, and instructions corresponding to generation of the final code; and
generating, through the LLM unit, the final code in response to the final code generation prompt.

11. A system for multi-agent based code generation, the system comprising:
a processor; and
a memory communicatively coupled to the processor, wherein the memory stores processor instructions, which when executed by the processor, cause the processor to:
receive a name of a target module from a User Interface (UI), wherein the target module is one of a plurality of modules in an existing codebase;
based on the name of the target module, retrieve software architecture design details and visual data insights from a first knowledge base, and a design guidelines summary and a module implementation report from a second knowledge base, wherein the first knowledge base is a vector database based on software architecture design documents, and wherein the second knowledge base is a vector database based on domain-specific design documents and the existing codebase;
generate, through a LLM unit, a high-level pseudocode corresponding to the target module based on the software architecture design details and the visual data insights;
generate, through the LLM unit, an executable code corresponding to the target module based on the high-level pseudocode;
generate, through the LLM unit, an optimized code from the executable code based on the design guidelines summary; and
review, through the LLM, the optimized code based on the module implementation report to obtain a final code corresponding to the target module.

12. The system of claim 11, wherein:
the software architecture design details comprises module specifications, data flow, state management, and module relationships,
the design guidelines summary comprises coding standards, design patterns, best practices, and implementation strategies, and
the module implementation report comprises core functionalities and implementation details of the target module.

13. The system of claim 11, wherein to generate the software architecture design details, the processor instructions, on execution, further cause the processor to:
extract data and the visual data insights from the software architecture design documents in text format, wherein the data comprise text data and image data, and wherein the visual data insights are extracted through a vision LLM;
create a first set of architecture chunks corresponding to the text data of the software architecture design documents using a text splitter; and
create a first set of architecture embeddings based on the first set of architecture chunks using an embedding model.

14. The system of claim 13, wherein to generate the software architecture design details, the processor instructions, on execution, further cause the processor to:
input a primary details generation prompt to the LLM unit, wherein the primary details generation prompt comprises the first set of architecture embeddings and instructions corresponding to individual generation of primary software architecture design details;
generate, through the LLM unit, primary software architecture design details in response to the primary details generation prompt;
generate, through the LLM unit, an individual query corresponding to each of the primary software architecture design details from a high-level query using a structured prompt;
create a second set of architecture embeddings based on the individual query using the embedding model;
compare the second set of architecture embeddings and the first set of architecture embeddings using a similarity search to obtain relevant embeddings from the first set of architecture embeddings;
input a secondary details generation prompt to the LLM unit, wherein the secondary details generation prompt comprises the relevant embeddings and instructions corresponding to individual generation of the software architecture design details;
generate, through the LLM unit, the software architecture design details in response to the secondary details generation prompt; and
store the software architecture design details and the visual data insights in the first knowledge base.

15. The system of claim 11, wherein to generate the design guidelines summary, the processor instructions, on execution, further cause the processor to:
extract data from the domain-specific design documents in text format;
create a set of design chunks corresponding to the domain-specific design documents using a text splitter;
input a primary summarization prompt to the LLM unit, wherein the primary summarization prompt comprises the set of design chunks and instructions corresponding to individual summary generation of each of the set of design chunks;
generate, through the LLM unit, a summary corresponding to each of the set of design chunks in response to the primary summarization prompt;
input a secondary summarization prompt to the LLM unit, wherein the secondary summarization prompt comprises the summary and instructions corresponding to generation of the design guidelines summary based on the summary;
generate, through the LLM unit, the design guidelines summary in response to the secondary summarization prompt, wherein the design guidelines summary is a consolidated summary based on the summary for each of the set of design chunks; and
storing the design guidelines summary in the second knowledge base.

16. The system of claim 11, wherein to generate the module implementation report the processor instructions, on execution, further cause the processor to:
split the existing codebase into the plurality of modules using a text splitter;
create a set of module embeddings from the plurality of modules using an embedding model;
create a set of target module embeddings from the name of the target module using an embedding model;
compare the set of module embeddings and the set of target module embeddings using a similarity search to obtain relevant module embeddings from the set of module embeddings;
input a report generation prompt to the LLM unit, wherein the report generation prompt comprises the relevant module embeddings and instructions corresponding to generation of the module implementation report;
generate, through the LLM unit, the module implementation report in response to the report generation prompt; and
storing the module implementation report in the second knowledge base.

17. The system of claim 11, wherein to generate the high-level pseudocode, the processor instructions, on execution, further cause the processor to, at least one of:
input a pseudocode generation prompt to the LLM unit, wherein the pseudocode generation prompt comprises the software architecture design details and instructions corresponding to generation of the high-level pseudocode; and
generate, through the LLM unit, the high-level pseudocode in response to the pseudocode generation prompt.

18. The system of claim 11, wherein to generate the executable code corresponding to the target module, the processor instructions, on execution, cause the processor to:
input an executable code generation prompt to the LLM unit, wherein the executable code generation prompt comprises the high-level pseudocode and instructions corresponding to generation of the executable code; and
generate, through the LLM unit, the executable code in response to the executable code generation prompt.

19. The system of claim 11, wherein to generate the optimized code from the executable code, the processor instructions, on execution, cause the processor to:
input an optimized code generation prompt to the LLM unit, wherein the optimized code generation prompt comprises the executable code, the design guidelines summary, and instructions corresponding to generation of the optimized code; and
generate, through the LLM unit, the optimized code in response to the optimized code generation prompt.

20. The system of claim 11, wherein to review the optimized code based on the module implementation report, the processor instructions, on execution, cause the processor to:
input a final code generation prompt to the LLM unit, wherein the final code generation prompt comprises the optimized code, the module implementation report, and instructions corresponding to generation of the final code; and
generate, through the LLM unit, the final code in response to the final code generation prompt.
